(19) United States
(12) Patent Application Publication
(10) Pub. No.: US 2019/0248190 A1
(43) Pub. Date: Aug. 15, 2019

(54) TIRE AIRBAG APPARATUS

(71) Applicant: Saed S. Kawar, Jacksonville, FL (US)

(72) Inventor: Saed S. Kawar, Jacksonville, FL (US)

(21) Appl. No.: 15/892,888

(22) Filed: Feb. 9, 2018

(51) Int. Cl. B60C 17/02

(52) U.S. Cl. CPC B60C 17/02

(57) ABSTRACT

The present invention is a tire airbag apparatus placed within a vehicle tire and disposed about its rim which will inflate to prevent the tire from completely collapsing in the event of a puncture or rupture. The airbag apparatus includes a circumferential inner tube removably mounted on the rim member and includes a tire damage sensor member and an inflator member. The inflator member is configured to be activated when the tire damage sensor detects a drop in pressure in the tire in the event of a puncture or rupture so as to inflate the tire. Thus, the tire airbag apparatus will allow the user to continue to drive safely over a given distance until the tire can be replaced or repaired.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of automobile tire accessories art and more specifically relates to a tire airbag apparatus.

### 2. DESCRIPTION OF THE RELATED ART

When a vehicle tire is damaged and rapidly deflates due to an unexpected puncture or the like, the vehicle is unable to continue and the tire must be repaired or replaced before driving can continue. This is both inconvenient and dangerous as tire failures often result in the loss of vehicle control, serious injuries and fatalities.

In the past various solutions have been proposed to allow at least limited continued driving of a vehicle after a tire loses inflation. U.S. Pat. No. 4,177,848 to Van der Burg; U.S. Pat. No. 8,327,897 to Firestone; U.S. Pat. No. 2,554,815 to Church; U.S. Pat. No. 7,891,393 to Czarno; and U.S. Pat. No. 5,313,995 to Schultz present various solutions.

However, these solutions rely upon costly and complicated structures such as inflatable rim shoulders which continue to function after a flat has occurred so that the wheels will remain operative; an inflation system that relies upon a sealing and inflating compound to seal a tear or rupture, a sensor that detects the presence of a rupture in a tire and initiates a sealant from a cartridge to inflate the tire.

Thus there is a need for a means of rapidly inflating a tire upon puncture and, yet would operate reliably, be easy to install, and capable of being manufactured at a modest expense.

### BRIEF SUMMARY OF THE INVENTION

The present invention provides a novel tire airbag apparatus. The general purpose of the present invention, which will be described subsequently in greater detail, is to provide an inner tube with a tire damage sensor member that is configured to activate an inflator member when there is a blowout of the tire or a sudden loss in tire pressure. When a loss in pressure is detected by the sensor, the inner tube is rapidly activated by the inflator member allowing the motorist to continue in safety.

The tire airbag apparatus of the present invention is attached to the rim of a tire and includes a tire damage sensor member which can detect a loss in pressure of the tire. When a loss in pressure is detected by the tire damage sensor member a signal is sent to an inflator member whereby a circumferential inner tube rapidly inflates thereby allowing a motorist to continue safely on their way for a given distance until the tire can be replaced or repaired.

The tire airbag apparatus is attached to the rim of a wheel and is available for various sized wheels. The airbag apparatus also includes a tire sealant such that the inner tube will not explode as it expands against a nail or similar article. The inner tube would ideally hold for 24 hours allowing the motorist to have the tire repaired or replaced.

The present invention holds significant improvements and serves as a tire airbag. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments of use for the present invention, a tire airbag apparatus, constructed and operative according to the teachings of the present invention.

FIG. 1 shows a cut-away view illustrating a Tire Airbag Apparatus according to an embodiment of the present invention.

FIG. 2 is a close-up cut-away view illustrating a Tire Airbag Apparatus according to an embodiment of the present invention of FIG. 1.

FIG. 3 is a perspective view illustrating Tire Airbag Apparatus with the circumferential outer covering opening as the circumferential inner tube inflates according to an embodiment of the present invention of FIG. 1.

FIG. 4 is a perspective view illustrating Tire Airbag Apparatus in use on a car with the tire member omitted depicting the inflated circumferential inner tube and schematically illustrating the inflator member according to an embodiment of the present invention of FIG. 1.

The various embodiments of the present invention will hereinafter be described in conjunction with the appended drawings, wherein like designations denote like elements.

### DETAILED DESCRIPTION

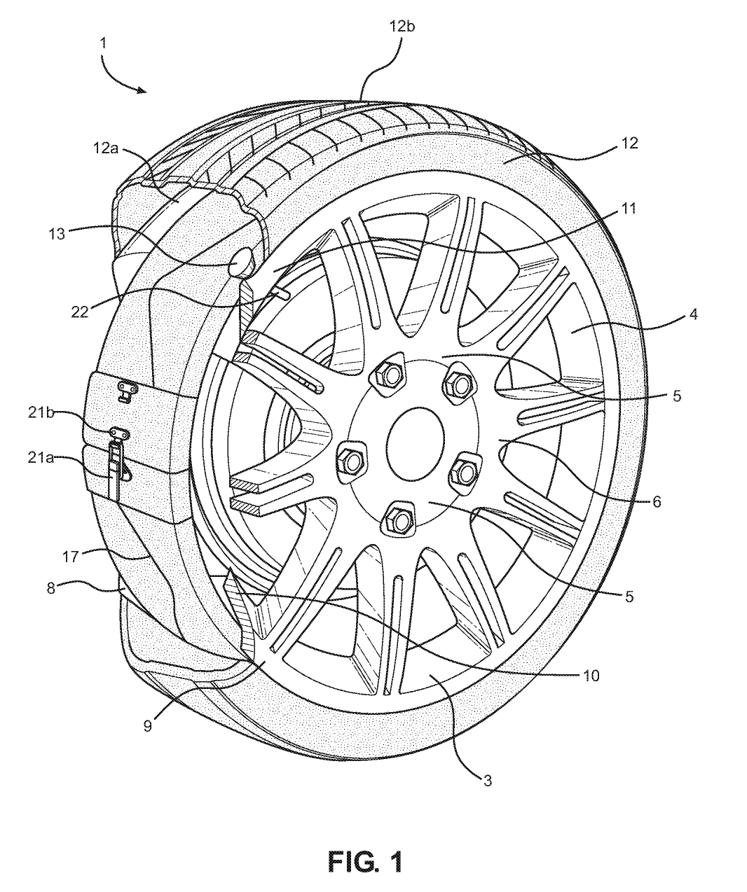

Referring to the drawings by numerals of reference there is shown in FIGS. 1-4, a tire airbag apparatus 1 (FIG. 1) for use upon a rim member 4, of a wheel 6 of a vehicle 7 (FIG. 3). The tire airbag apparatus 1 is comprised of a circumferential inner tube 2 wherein the circumferential inner tube 2 is adapted to be removably mounted onto and around a circumference of a circumferential tire mounting portion 3 of the rim member 4 of the wheel 6 of the vehicle 7.

The circumferential inner tube 2 (FIG. 1) is located between the inboard flange 8 and outboard flange 9 of the rim member 4 of the wheel 6 and is adapted to be located in between a bottom wall 10 of the rim member 4 and an inner wall surface 12A of a tire member 12 mounted upon the rim member 4.

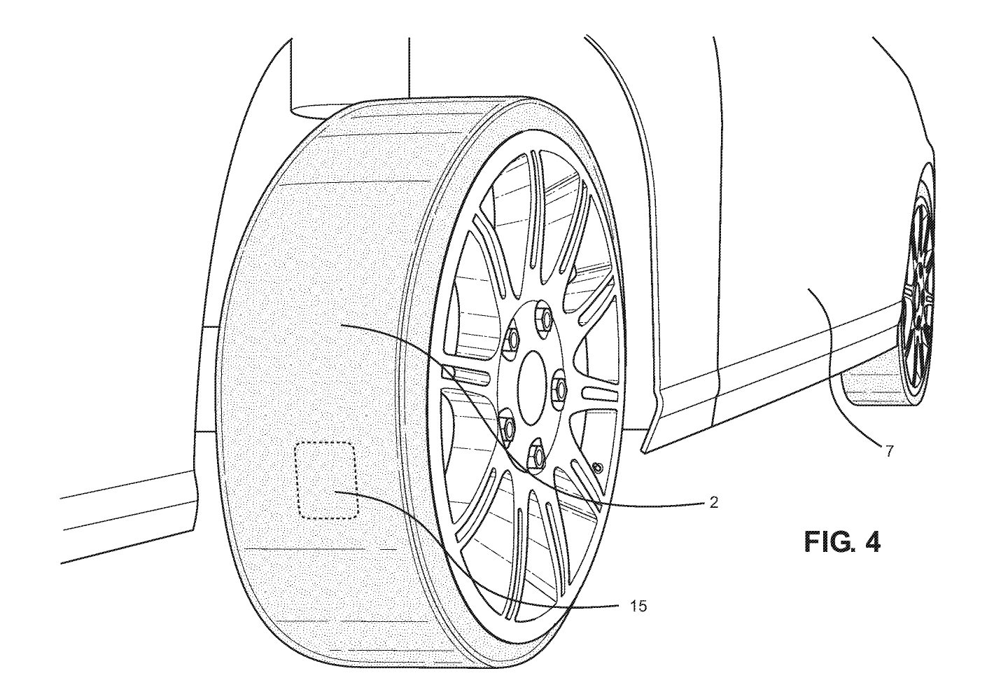

The tire airbag apparatus 1 also includes a tire damage sensor member 13. The tire damage sensor member 13 is adapted to be removably attached to an inner surface 11 of one of the inboard flange 8 or outboard flange 9 of the rim member 4. The damage sensor member 13 is adapted to detect damage to the tire member 12 that may result in the loss of air pressure within the tire member 12. The tire damage sensor 13 is configured to send an electronic signal to an inflator member 15 whenever damage is detected. The inflator member 15 is shown schematically in a break-away section in FIG. 4.

Exemplary tire damage sensors may include a PSI sensor arranged to detect pressure in a pressurized interior space of the tire member 12 and configured to send the electronic signal to actuate the inflator member 15 when the air pressure drops below a certain predetermined pressure level. Alternately, the electronic signal may be manually triggered by a switch suitably provided within the vehicle and readily accessible to the motorist.

The inflator member 15 is attached to the circumferential inner tube 2 and is electronically connected to the tire damage sensor 13. The inflator member 15 is configured to inflate the circumferential inner tube 2 when the electronic signal is received from the tire damage sensor member 13 indicating that the tire member 12 has been damaged.

The inflator member 15 may be one of several suitable sources of providing pressurized gas to enable the inflation of the circumferential inner tube 2. One source may be that of mixing and reacting chemicals stored in a container to form a pressurized gas. The container may have chemicals such as sodium azide with potassium nitrate to produce nitrogen gas which upon receipt of the electronic signal from the tire damage sensor member 13 are mixed and react to form blasts of gas. Furthermore, the circumferential inner tube 2 may have a tire sealant in it so that if there is a puncture from a nail present in the tire member 12, the circumferential inner tube 2 won't rupture or explode when it expands there against.

The tire airbag apparatus 1 further includes a circumferential outer covering 16 (FIG. 3) which is adapted to cover and protect the circumferential inner tube 2 until damage is detected by the tire damage sensor member 13 and the inflator member 15 begins to inflate the circumferential inner tube 2.

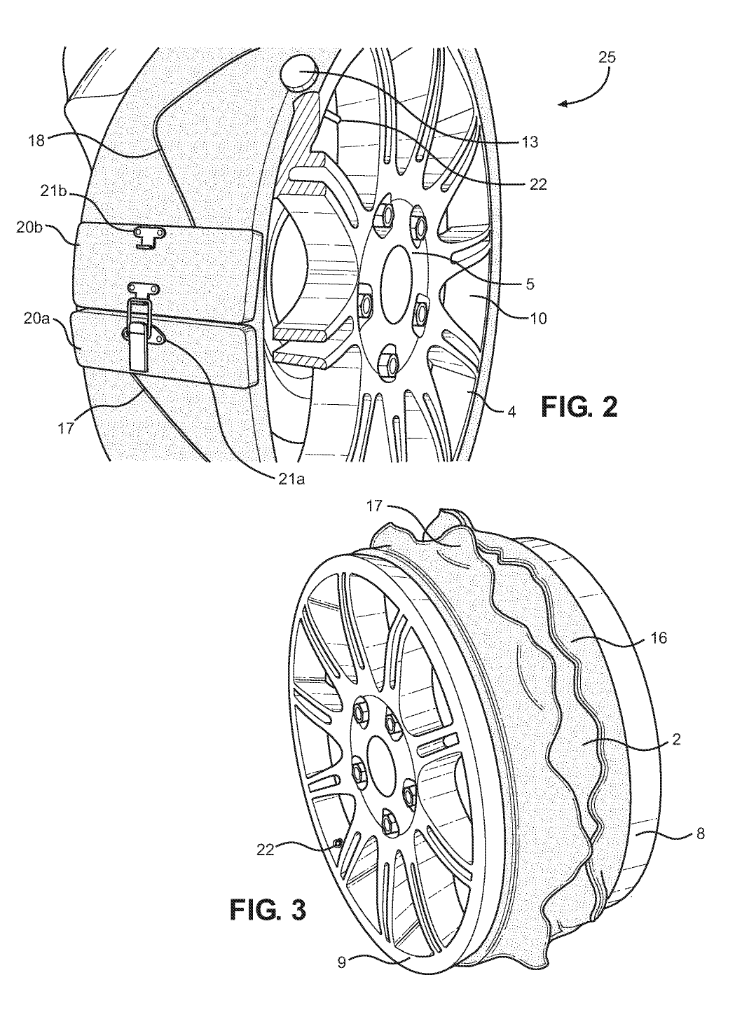

The circumferential outer covering 16 includes a scoring 17 (FIG. 2) thereon which is adapted to split when a predetermined air pressure is reached within the circumferential inner tube 2 when being inflated by the inflator member 15 such that the circumferential inner tube 2 can break therethrough and inflate completely. The scoring 17 is formed in a zig-zag pattern 18 along a circumferential length thereof.

The circumferential outer covering 16 is formed of a flexible material and includes two opposite ends 20a, 20b (FIG. 2) adapted to be removably connected to one another such that the circumferential outer covering 16 is adapted to be removably wrapped around the circumference of the rim member 4 and to protect the circumferential inner tube 2 therebetween until being inflated.

The two opposite ends 20a,b include mating releasable connector members 21a,b adapted to releasably connect the two opposite ends 20a,b. One of the opposite ends 20a includes one releasable connector member 21a (FIG. 1) thereon and the other of the two opposite ends 20b includes a plurality of spaced releasable connector members 21b thereon such that one releasable connector member 21a can be releasably connected to any one of the plurality of spaced releasable connector members 21b. This allows for the adjustability of the airbag apparatus to be used on rim members 4 of different sizes.

As set forth above, the present invention provides for an improved vehicle tire apparatus 25 (FIG. 2), including the rim member 4, and a hub member mounting plate 5, wherein the hub mounting plate 5 is adapted to releasably mount the improved vehicle tire apparatus 25 to an axle hub of a vehicle 7. The rim member 4 also includes an aperture therethrough for a valve stem 22 which extends through a bottom wall 10 of the rim member 4. The valve stem 22 allows air to pass therethrough and inflate the tire member 12. The valve stem 22 is located under the sensor 13 to prevent it from being damaged when the tire is changed.

The tire member 12 includes an inner wall surface 12A and an outer wall surface 12B (FIG. 1) wherein the tire member 12 is removably mountable onto the rim member 4 in between the inboard flange 8 and outboard flange 9. The tire member 12 is adapted to be filled with air via the valve stem 22.

The improved vehicle tire apparatus 25 has the circumferential outer covering 16 (FIG. 3) which is adapted to cover and protect the circumferential inner tube 2 until damage is detected by the tire damage sensor member 13 and the inflator member 15 begins to inflate.

FIG. 4 depicts the improved vehicle tire apparatus 25 with the tire member 12 and the circumferential outer covering 16 omitted for clarity. Shown is the circumferential inner tube 2 in the inflated state which will provide sufficient support to the damaged tire member to allow the motorist to continue safely for a given distance until the tire can be repaired or replaced. The inflator member 15 is schematically shown in a break-away section of the circumferential inner tube 2.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A tire airbag apparatus for use upon a rim member of a wheel of a vehicle, comprising:
a circumferential inner tube;
wherein said circumferential inner tube is adapted to be removably mounted onto and around a circumference of a circumferential tire mounting portion of a rim member of a wheel of a vehicle and located in between inboard and outboard flanges thereof, and is adapted to be located in between a bottom wall of said rim member and an inner wall surface of a tire member mounted upon said rim member;
a tire damage sensor member;
wherein said tire damage sensor member is adapted to be removably attached to an inner surface of one of said inboard and outboard flanges of said rim member, is adapted to detect damage to said tire member that may result in the loss of tire air pressure within said tire member, and is adapted to send an electronic signal therefrom when damage is detected;
an inflator member;
wherein said inflator member is attached to said circumferential inner tube, is electronically connected to said tire damage sensor member, and is adapted to inflate said circumferential inner tube when a signal is received from said tire damage sensor member that said tire member has been damaged.

2. The tire airbag apparatus of claim 1, further comprising:
a circumferential outer covering;
wherein said circumferential outer covering is adapted to cover and
protect said circumferential inner tube until damage is detected by said tire damage sensor member and said inflator member begins to inflate said circumferential inner tube.

3. The tire airbag apparatus of claim 2, wherein said circumferential outer covering includes a scoring thereon adapted to split when a predetermined air pressure is reached within said circumferential inner tube when being inflated by said inflator member, such that said circumferential inner tube can break therethrough and inflate completely.

4. The tire airbag apparatus of claim 3, wherein said scoring of said circumferential outer covering is formed in a zig-zag pattern along a circumferential length thereof.

5. The tire airbag apparatus of claim 3, wherein said circumferential outer covering is formed from a flexible material and includes two opposite ends adapted to be removably connected to one another, such that said circumferential outer covering is adapted to be removably wrapped around said circumference of said rim member and enclose and protect said circumferential inner tube therebetween until being inflated.

6. The tire airbag apparatus of claim 5, wherein said two opposite ends includes mating releasable connector members adapted to releasably connect said two opposite ends.

7. The tire airbag apparatus of claim 6, wherein one of said two opposite ends includes one releasable connector member thereon, and said other of said two opposite ends includes a plurality of spaced releasable connector members thereon, such that said one releasable connector member can be releasably connected to any one of said plurality of spaced releasable connector members depending on the size of said rim member used thereupon.

8. An improved vehicle tire apparatus comprising:
a rim member including:
a hub mounting plate;
wherein said hub mounting plate is adapted to releasably
mount said improved vehicle tire apparatus to an axle hub of a vehicle; and
a circumferential tire mounting portion including:
a circumference there around;
an inboard flange;
an outboard flange; and
a bottom wall including:
an aperture therethrough for housing valve stem;
wherein said bottom wall is connected between said inboard flange and said outboard flange;
wherein said circumferential tire mounting portion is connected to said hub mounting plate;
a valve stem;
wherein said valve stem is attached to and extends through said aperture in said circumferential tire mounting portion, and is adapted to allow air to pass therethrough and inflate a tire member mounted upon said circumferential tire mounting portion;
a tire member including:
an inner wall surface; and
an outer wall surface;
wherein said tire member is removably mountable onto said rim member in between said inboard and outboard flanges, and is adapted to be filled with air via said valve stem;
a circumferential inner tube;
wherein said circumferential inner tube is removably mountable onto and located around said circumference of said circumferential tire mounting portion of said rim member and in between said inboard and outboard flanges thereof, and is adapted to be located in between said bottom wall of said rim member and said inner wall surface of said tire member;
a tire damage sensor member;
wherein said tire damage sensor member is removably attached to an inner surface of one of said inboard and outboard flanges, is adapted to detect damage to said tire member that may result in the loss of tire air pressure, and is adapted to send an electronic signal therefrom when damage is detected;
an inflator member;
wherein said inflator member is attached to said circumferential inner tube, is electronically connected to said tire damage sensor member, and is adapted to inflate said circumferential inner tube when a signal is received from said tire damage sensor member that said tire member has been damaged.

9. The improved vehicle tire apparatus of claim 8, further comprising:
a circumferential outer covering;
wherein said circumferential outer covering is adapted to cover and
protect said circumferential inner tube until damage is detected by said tire damage sensor member and said inflator member begins to inflate said circumferential inner tube.

10. The improved vehicle tire apparatus of claim 9, wherein said circumferential outer covering includes a scoring thereon adapted to split when a predetermined air pressure is reached within said circumferential inner tube when being inflated by said inflator member, such that said circumferential inner tube can break therethrough and inflate completely.

11. The improved vehicle tire apparatus of claim 10, wherein said scoring of said circumferential outer covering is formed in a zig-zag pattern along a circumferential length thereof.

12. The improved vehicle tire apparatus of claim 10, wherein said circumferential outer covering is formed from a flexible material and includes two opposite ends adapted to be removably connected to one another, such that said circumferential outer covering is adapted to be removably wrapped around said circumference of said rim member and enclose and protect said circumferential inner tube therebetween until being inflated.

13. The improved vehicle tire apparatus of claim 12, wherein said two opposite ends includes mating releasable connector members adapted to releasably connect said two opposite ends.

14. The improved vehicle tire apparatus of claim 13, wherein one of said two opposite ends includes one releasable connector member thereon, and said other of said two opposite ends includes a plurality of spaced releasable connector members thereon, such that said one releasable connector member can be releasably connected to any one of said plurality of spaced releasable connector members depending on the size of said rim member used thereupon.
